(19) United States
(12) Patent Application Publication
(10) Pub. No.: US 2023/0270288 A1
(43) Pub. Date: Aug. 31, 2023

(54) LOCK MEMBER, ROTARY HEAD, ROTARY ASSEMBLY, SHAFT COUPLER, CONTAINER, AND FOOD PROCESSOR

(71) Applicant: GUANGDONG MIDEA CONSUMER ELECTRIC MANUFACTURING CO., LTD., Foshan (CN)

(72) Inventors: Christopher BURTON, Foshan (CN); Qingchu HUANG, Foshan (CN); Jianfei XU, Foshan (CN)

(21) Appl. No.: 18/014,643

(22) PCT Filed: Aug. 3, 2020
(86) PCT No.: PCT/CN2020/106542

§ 371 Date: Jan. 5, 2023

(30) Foreign Application Priority Data
Jul. 6, 2020 (CN) 202010643126.6
Jul. 6, 2020 (CN) 202021303584.7

(51) Int. Cl. A47J 43/07; A47J 43/046; A47J 43/08; A47J 19/02; A21C 1/14; B01F 27/07; B01F 35/31

(52) U.S. Cl. CPC A47J 43/0716; A47J 43/046; A47J 43/085; A47J 19/02; A21C 1/1465; A21C 1/1415; B01F 27/071; B01F 35/31; B01F 2035/351

(57) ABSTRACT

A lock member includes a housing, a movement body, and an elastic member. The housing includes an open groove at an inner wall of the housing. A bottom of the open groove is provided with a movement surface. An end of the movement surface proximal to an opening of the open groove is a locking end, and an end of the movement surface distal to the opening of the open groove is an unlocking end. The movement body is provided in the open groove and moveable along the movement surface. The elastic member is provided in the open groove and configured to maintain the movement body at the locking end or the unlocking end of the movement surface.

### CROSS-REFERENCE TO RELATED APPLICATIONS

The present application claims priority to Chinese patent applications, entitled “Lock member, Rotary Head, Rotary Assembly, Shaft coupler, Container, and Food Processor,” No. 202010643126.6, filed on Jul. 6, 2020, and entitled “Lock member, Rotary Head, Rotary Assembly, Shaft coupler, Container, and Food Processor,” No. 202021303584.7, filed on Jul. 6, 2020, the disclosures of which are hereby incorporated by reference in their entity.

### TECHNICAL FIELD

The present application relates to the technical field of material processing, in particular to a lock member, a rotary head, a rotary assembly, a shaft coupler, a container and a food processor.

### BACKGROUND

With the development of science and technology, mixing device, such as dough kneading machine, soybean milk machine, juice extractor, and high speed blender, is more and more used in people's daily life. These mixing devices are driven to cut and/or mix materials automatically by driving stirring blades or stirring paddles or other similar parts to mix through drive shafts.

However, in order to ensure reliable connection between the stirring blades or stirring paddles or the like and the drive shafts when the drive shafts are rotating, so that these parts won't be thrown out of the mixing device, most of the existing stirring blades or stirring paddles or the like are fixed on the drive shafts. As a result, the existing stirring blades or stirring paddles or the like are not easily disassembled, or it requires a lot of time and effort even if disassembled, which makes it difficult for the user to clean the stirring blades or stirring paddles and the bottoms of the mixing devices after using them, leading to one of the main dissatisfactions of the user.

In addition, when the user directly reaches their hand into the mixing device having stirring blades for cleaning, it's easy to cut his/her hand by the sharp blades, which is another dissatisfaction of the user.

Moreover, a mixing device generally includes a stirring cup and a base. The output end of the power mechanism in the base is connected to the connection end of the stirring assembly of the stirring container, then the power mechanism can drive the stirring assembly to rotate so as to cut and/or mix materials in the stirring container automatically.

Nevertheless, in the related art, the output end of the power mechanism and the connection end of the stirring assembly are connected by a plurality of protrusions and a plurality of grooves. When it's needed to place the stirring cup on the base, it is necessary to accurately align the plurality of protrusions and the plurality of grooves, which requires to continually rotate the stirring cup to ensure that the plurality of protrusions can be inserted into the plurality of grooves, which is inconvenient and time-consuming, and it is also one of the main dissatisfactions of the user. In addition, in the stirring process of the mixing device, since the heat generated at the junctions of the protrusions and the grooves is large, the requirement for the mixing time is high, for example, the mixing time needs to be controlled in a short time, and for the materials that are difficult to stir or cut, it is even necessary to suspend for a period of time for heat dissipation, and wait for the connections between the protrusions and the grooves to cool and then continue to stir or cut, which brings great inconvenience to the user. Moreover, it is difficult to avoid the gaps between the protrusions and the grooves, which leads to large noise and vibration in the working process, affecting the user's feeling of use, which is also one of the main dissatisfactions of the user.

### SUMMARY

An objective of the present application is to solve at least one of the technical problems existing in the existing technologies or related art.

In a first aspect, the present application provides a lock member to facilitate locking and unlocking.

In a second aspect, the present application provides a rotary head and a rotary assembly to solve the problem that the existing rotary head is not easy to disassemble.

In a third aspect, the present application provides a container and a food processor to solve the problem that users are not easy to clean mixing device or even prone to cut their hands due to the inconvenience of removing the rotary head.

In a fourth aspect, the present application provides a shaft coupler and a rotary assembly to facilitate the assembly and disassembly between the rotary head and a drive shaft assembly, and the shaft coupler and the rotary assembly can be bidirectionally locked with the drive shaft assembly.

In a fifth aspect, the present application provides a container and a food processor to solve the problems of inconvenient connection, large heat generation, large vibration and high noise between the drive shaft assembly of existing container body and the drive shaft assembly of existing base.

In order to solve the technical problems above, in a first aspect, embodiments of the present application provide a lock member, including:
a housing, where, an inner wall of the housing is provided with a first open groove, a bottom of the first open groove is provided with a first movement surface, an end of the first movement surface proximal to an opening of the first open groove is a locking end, and an end of the first movement surface distal to the opening of the first open groove is an unlocking end;
a first movement body, provided in the first open groove and movable along the first movement surface; and
a first elastic member, provided in the first open groove, where the first elastic member is capable of maintaining the first movement body at the locking end or the unlocking end of the first movement surface.

In another embodiment of the present application, the inner wall of the housing is further provided with a second open groove, a bottom of the second open groove is provided with a second movement surface, and a tilt direction of the second movement surface is opposite to that of the first movement surface;
an end of the second movement surface proximal to an opening of the second open groove is a locking end, and an end of the second movement surface distal to the opening of the second open groove is an unlocking end;
a second movement body is provided in the second open groove and the second movement body is movable along the second movement surface; and
a second elastic member is provided in the second open groove, and the second elastic member is capable of maintaining the second movement body at the locking end or the unlocking end of the second movement surface.

In an embodiment of the present application, a plurality of the first open grooves are provided, the plurality of first open groove are disposed at intervals on the inner wall of the housing, and a length direction of the plurality of first open grooves extends along an axial direction of the housing.

In an embodiment of the present application, a plurality of the second open grooves are provided, the plurality of second open grooves are disposed at intervals on the inner wall of the housing, and a length direction of the plurality of second open grooves extends along an axial direction of the housing.

In an embodiment of the present application, the first open grooves and the second open grooves are provided in pairs.

In an embodiment of the present application, the first elastic member is installed at the unlocking end of the first movement surface or at a position near the unlocking end of the first movement surface; the first elastic member, when in a natural state, maintains the first movement body at the locking end of the first movement surface, and an outer surface of the first movement body towards the opening of the first open groove is tangent to a circumference of the inner wall of the housing.

In an embodiment of the present application, the second elastic member is installed at the unlocking end of the second movement surface or at a position near the unlocking end of the second movement surface; the second elastic member, when in a natural state, maintains the second movement body at the locking end of the second movement surface, and an outer surface of the second movement body towards the opening of the second open groove is tangent to a circumference of the inner wall of the housing.

In an embodiment of the present application, a maximum width between opposite sidewalls of the first open groove is larger than a width of the opening of the first open groove, and a diameter of the first movement body is larger than the width of the opening of the first open groove and smaller than the maximum width between the opposite sidewalls of the first open groove.

In an embodiment of the present application, a sidewall of the first open groove located at the unlocking end of the first movement surface is provided with a first installation groove for the first elastic member, and a tilt direction of the first installation groove is consistent with that of the first movement surface.

In an embodiment of the present application, a maximum width between opposite sidewalls of the second open groove is larger than a width of the opening of the second open groove, and a diameter of the second movement body is larger than the width of the opening of the second open groove and smaller than the maximum width between the opposite sidewalls of the second open groove.

In an embodiment of the present application, a sidewall of the second open groove located at the unlocking end of the second movement surface is provided with a second installation groove for the second elastic member, and a tilt direction of the second installation groove is consistent with that of the second movement surface.

In an embodiment of the present application, the sidewall of the first open groove at the locking end of the first movement surface is constructed as a first arc surface matching the outer surface of the first movement body.

In an embodiment of the present application, the sidewall of the second open groove at the locking end of the second movement surface is constructed as a second arc surface matching the outer surface of the second movement body.

In an embodiment of the present application, both the first movement body and the second movement body are roller pins, rollers or balls, and both the first elastic member and the second elastic member are springs.

In an embodiment of the present application, at least one end along an axial direction of the housing has an end cover, the end cover has a central through hole, and an inner diameter of the central through hole is not small than that of an axial through hole of the housing.

In a second aspect, embodiments of the present application further provide a rotary head, including:
an installation sleeve, having an installation space on a lower end thereof;
the lock member, is fixed in the installation space through the housing; and
a rotary actuator, fixed outside the installation sleeve.

In an embodiment of the present application, an upper end of the installation sleeve bulges upwards to form a connection member; and an annular convex platform is constructed outside the installation sleeve at an opening side of the installation space, the rotary actuator is fixed to an outer side of the installation sleeve and abuts on the annular convex platform, the connection member is connected to a handle sleeve, and the handle sleeve is sleeved at the outer side of the installation sleeve and is pressed on the rotary actuator.

In an embodiment of the present application, the rotary head further includes a sealing member, the sealing member is provided at a lower end of the lock member; and

the sealing member is at least partially provided in the installation space and located at an opening side of the installation space.

In an embodiment of the present application, the rotary head further includes a first magnetic member fixed at the opening side of the installation space.

In an embodiment of the present application, the rotary actuator includes rotary knife, rotary hook, rotary claw, rotary rod or rotary paddle, or any combination thereof.

In a third aspect, embodiments of the present application further provide a rotary assembly, including a driver assembly and the rotary head, where, the rotary head is sleeved at the driver assembly, and the driver assembly contacts with the first movement body.

In an embodiment of the present application, the rotary assembly further includes a second magnetic member, which is fixed on the driver assembly and is provided opposite to the first magnetic member of the rotary head, and the first magnetic member and the second magnetic member magnetically attract each other.

In a fourth aspect, embodiments of the present application further provide a container, including a container body, further including: the rotary assembly, an end of the driver assembly is installed in the container body, and the rotary head is sleeved at the other end of the driver assembly through the housing.

In a fifth aspect, embodiments of the present application further provide a food processor, including the container, and the food processor can be soybean milk machine, high speed blender, juice extractor, egg beater, dough kneading machine, food mixer, air fryer, shredder, filament planer, self-cooking pan, frying pan, soup-making machine or self-frying pan.

In a sixth aspect, embodiments of the present application further provide a shaft coupler, including a shaft coupler body, where a first end of the shaft coupler body is provided with a first connection hole and a second end of the shaft coupler body is provided with a second connection hole. The shaft coupler further includes:
the lock member; where
the housing is fixed in the first connection hole and is configured to be sleeved at a first drive shaft assembly, and the second connection hole is configured to be fixedly connected to a second drive shaft assembly.

In an embodiment of the present application, the first connection hole and the second connection hole are coaxially arranged and not communicated with each other.

In a seventh aspect, the embodiments of the present application further provide a rotary assembly, including a first drive shaft assembly and a second drive shaft assembly, further including: the shaft coupler which is sleeved at the first drive shaft assembly through the housing, the first movement body contacts with the first drive shaft assembly, and the second drive shaft assembly is fixedly connected to the second connection hole.

In an eighth aspect, embodiments of the present application further provide a container, including a container body and a base, further including: the rotary assembly, where, one of the first drive shaft assembly and the second drive shaft assembly is connected to the container body and extends into the container body, and the other one of the first drive shaft assembly and the second drive shaft assembly is connected to the base.

In an embodiment of the present application, an end of the first drive shaft assembly or the second drive shaft assembly extended into the container body is provided with a rotary actuator; the base is provided with a power mechanism; and an end of the first drive shaft assembly or the second drive shaft assembly connected to the base is connected to the power mechanism.

In a ninth aspect, embodiments of the present application further provide a food processor, including the container according to the eighth aspect, which can be soybean milk machine, high speed blender, juice extractor, egg beater, dough kneading machine, food mixer, air fryer, shredder, filament planer, self-cooking pan, frying pan, soup-making machine or self-frying pan.

Compared with the related art, the embodiments of the present application have the following beneficial effects.

Embodiments of the present application provide a lock member, where, an inner wall of the housing is provided with a first open groove, a bottom of the first open groove is provided with a first movement surface, an end of the first movement surface proximal to an opening of the first open groove is a locking end, and an end of the first movement surface distal to the opening of the first open groove is an unlocking end; a first movement body, which is provided in the first open groove and can move along the first movement surface; and a first elastic member, which is provided in the first open groove, and the first elastic member can maintain the first movement body at the locking end or the unlocking end of the first movement surface. When the driver assembly to be assembled is inserted into the housing, the first movement body contacts with the driver assembly to be assembled. Since there is no gap between the first movement body and the driver assembly to be assembled, when the driver assembly rotates from the unlocking end to the locking end, the first movement body is locked on the driver assembly to be assembled, and the lock member can rotate synchronously with the driver assembly. When the driver assembly is not driven by external force, the first movement body is held against the driver assembly only by the elastic force of the first elastic member. Therefore, the lock member and the driver assembly can be separated along the axial direction of the driver assembly. It is only needed to overcome elastic force of the first elastic member and friction between the lock member and the driver assembly, which is very convenient and simple for consumers or users. Or when the driver assembly rotates from the locking end to the unlocking end, the driver assembly drives the first movement body to move along the first movement surface towards the unlocking end and presses the first elastic member. Since the space of the first open groove at the unlocking end is large, when the first movement body moves at the unlocking end, there is a gap between the first movement body and the driver assembly. When the driver assembly continues to rotate, the lock member remains stationary and plays a unidirectional locking role, and it is easy to separate the lock member and the driver assembly along the axial direction of the driver assembly. That is, when the driver assembly does not rotate or the driver assembly rotates from the locking end to the unlocking end, it can be easily separated the locking part and the driver assembly along the axial direction of the driver assembly; and when the driver assembly the is forced to rotate from the unlocking end to the locking end, the lock member is driven by the driver assembly to rotate in the same direction with the driver assembly, and the lock member may be also subjected to an external force, which is opposite to the rotating direction of the driver assembly. At this time, due to the two opposite forces, the lock between the lock member and the driver assembly is further strengthened under the elastic force of the first elastic member. That is, when the driver assembly is forced to rotate from the unlocking end to the locking end, the lock member and the driver assembly are in a locked state, and the lock member cannot be disengaged from the driver assembly.

When the lock member needs to be re-locked with the driver assembly, it only needs to rotate the driver assembly along the unlocking end towards the locking end. At this time, the first movement body moves towards the locking end along the first movement surface under the elastic force of the first elastic member. When the first movement body moves at the locking end, it contacts with the driver assembly and is locked on the driver assembly. Therefore, the lock member can rotate synchronously with the driver assembly.

When it is needed to remove the lock member, only when the driver assembly does not rotate or the driver assembly rotates from the locking end to the unlocking end, the lock member can be directly pulled out from the driver assembly to realize the separation of the lock member and the driver assembly; and for the case of fixed rotary assembly outside the housing, it is convenient to clean the rotary assembly.

Embodiments of the present application provide a rotary head, where, the lock member is fixed in the installation sleeve, the rotary head is sleeved at the driver assembly to be assembled through the housing, for example, on the drive shaft, and the first movement body in the housing contacts with the drive shaft to be assembled. When the drive shaft is rotated to make the first movement body locked on the drive shaft, the rotary head and the drive shaft can rotate synchronously. When the drive shaft does not rotate, the rotary head can be removed directly along the axial direction of the drive shaft. When the first movement body moves at the unlocking end driven by the reverse rotation of the drive shaft, there is a gap between the first movement body and the drive shaft, and when the drive shaft rotates, the rotary head is fixed, thereby realizing the unidirectional locking and convenient disassembly of the rotary head.

When the rotary head needs to be removed, the rotary head can be pulled out from the driver assembly by only applying a small amount of force; and convenient disassembly facilitates the cleaning of the rotary head. Moreover, the installation sleeve, the lock member and the rotary actuator together form an assembly, and the rotary head is disassembled and assembled as a whole, with no other extra parts involved, avoiding situations where one or more parts are missing. The disassembly and assembly are fast, and it does not need disassembly tools or the users' checking on whether the disassembly and assembly are in place. What's more, it can be disassembled repeatedly.

In addition, the lock member is used as the part connected to the driver assembly. When the rotary head is working, the first movement body is always stuck on the outer wall of the driver assembly, which can ensure that there is no gap between the driver assembly and the housing, thereby reducing noise and vibration when the rotary head is rotating, and reducing the heat conduction between the rotary head and the driver assembly.

Embodiments of the present application provide a container, by providing the driver assembly and the rotary head connected with the driver assembly in the container body, the rotary head can be tightly connected with the driver assembly when it is working, and when needed, a disassembly can be completed by either pulling out the rotary head directly or just reversely turning the rotary head by an angle. It is convenient to disassemble and clean the rotary head, and it is also convenient to clean the bottom of the container after the rotary head is disassembled, so as to avoid the residue gathering at the bottom of the container, especially a position around the bottom of the driver assembly. Thus, the container can be cleaned thoroughly without any sanitary dead angle, then the user's complaints can be addressed and the users' satisfaction can be improved.

An embodiment of the present application provides a food processor, such as soybean milk machine, high speed blender, juice extractor, egg beater or dough kneading machine, etc., which is equipped with the container above. For the food processor, it is also possible to achieve reliable connection and convenient disassembly of the rotary head. Thus it is convenient to remove the rotary head and clean it. It is also convenient to remove the rotary head and clean the bottom of the food processor after removing the rotary head. Thus, the food processor can be thoroughly cleaned without cleaning any dead angle. Thus, users need not to put their hands into the food processor to clean it, and there is no danger of cutting users' hand. The safety use improves users' satisfaction and the premium capacity of product.

Embodiments of the present application provide a shaft coupler. By fixing the lock member in the shaft coupler body, it only needs to insert the first drive shaft assembly, such as the drive shaft, into the housing or sleeve the housing onto the drive shaft when installing. Thus, the installation is convenient and fast without alignment and adjustment of installation angle.

The lock member is used as a part to connect to the first driver assembly. When the shaft coupler is working, the first movement body keeps locked on the outer wall of the first drive shaft assembly, which can ensure that there is no gap between the first drive shaft assembly and the housing, so as to reduce noise and vibration during the rotation of the shaft coupler.

Embodiments of the present application provide a rotary assembly, including the shaft coupler, the first drive shaft assembly and the second drive shaft assembly, where, the shaft coupler is fixedly connected to the second drive shaft assembly; and the shaft coupler is sleeved at the first drive shaft assembly through the housing. Thus, the installation of the rotary assembly is very convenient, without alignment and adjustment of any installation angle.

The container provided by the embodiments of the present application includes a container body and a base, where, one of the first drive shaft assembly and the second drive shaft assembly is connected to the container body and extends into the container body, and the other one of the first drive shaft assembly and the second drive shaft assembly is connected to the base. The first drive shaft assembly and the second drive shaft assembly are connected through the shaft coupler, and when assembling, all that is required is to insert the first drive shaft assembly into the housing. Thus, the installation is convenient, and there is no need to rotate the container body to adjust angle, so the installation is also fast, time-saving and labor-saving. When the container is working, the housing can be clamped with the first drive shaft assembly to ensure that there is no gap between the two, thus the rotation is more stable, the vibration and noise are small, and the heat generation is relatively small, which solves users' dissatisfaction.

Embodiments of the present application provide a food processor, such as soybean milk machine, high speed blender, juice extractor, egg beater, or dough kneading machine, etc., being equipped with the container above, which can also realize the rapid connection and convenient disassembly between the container body and the base. It ensures that there is no gap between the container body and the base when the food processor is working, thus the rotation is more stable with small vibration, noise and heat generation, which improves users' satisfaction and the premium capacity of product.

### BRIEF DESCRIPTION OF DRAWINGS

FIG. 1 is a cross-sectional view of a lock member as a one-way lock member according to an embodiment of the present application, wherein, the lock member is locked.

FIG. 2 is a cross-sectional view of a lock member as a one-way lock member according to an embodiment of the present application, wherein, the lock member is unlocked.

FIG. 3 is an exploded structure view of a lock member according to an embodiment of the present application.

FIG. 4 is a cross-sectional view of a lock member as a two-way lock member according to another embodiment of the present application, wherein, the lock member is locked.

FIG. 5 is a cross-sectional view of a lock member as a two-way lock member according to another embodiment of the present application, wherein, the lock member is unlocked.

FIG. 6 is an exploded structure view of a lock member according to another embodiment of the present application.

FIG. 7 is a front structure view of the lock member according to two embodiments of the present application.

FIG. 8 is a perspective structure view of the lock member according to two embodiments of the present application.

FIG. 9 is an axial section structure view of a rotary head without a rotary actuator according to an embodiment of the present application.

FIG. 10 is an axial section structure view of a rotary head according to an embodiment of the present application.

FIG. 11 is an axial section structure view of a drive shaft according to an embodiment of the present application.

FIG. 12 is an axial section structure view of a rotary assembly having a first magnetic member and a second magnetic member according to an embodiment of the present application.

FIG. 13 is an axial section structure view of a shaft coupler according to an embodiment of the present application.

FIG. 14 is a structure view of a container having a shaft coupler according to an embodiment of the present application.

FIG. 15 is a partial enlargement view at A in FIG. 14.

Reference numerals: installation sleeve 1; installation space 11; connection member 12; handle sleeve 13; annular convex platform 14; sealing member 15; lock member 2; housing 21; first movement body 22; second movement body 23; first open groove 24; first movement surface 24-1; second open groove 25; second movement surface 25-1; first elastic member 26; second elastic member 27; end cover 28; rotary actuator 3; drive shaft 4; annular hollow cover body 41; first magnetic member 5; second magnetic member 6; shaft coupler body 7; first connection hole 71; second connection hole 72; first drive shaft 8; second drive shaft 9; container body 10; base 20; fastener 30.

### DETAILED DESCRIPTION OF THE EMBODIMENTS

The specific implementations of the present application are further described in detail below in conjunction with the drawings and embodiments. The following embodiments are intended to illustrate the present application but are not intended to limit the scope of the present application.

In the description of the present application, it is to be noted that unless otherwise stated, the orientation or positional relations specified by terms such as “central,” “longitudinal,” “transverse,” “upper,” “lower,” “front,” “back,” “left,” “right,” “vertical,” “horizontal,” “top,” “bottom,” “inner,” “outer” etc., are based on the orientation or positional relations shown in the drawings, which is merely for convenience of description of the present application and to simplify description, but does not indicate or imply that the stated device or element must have the particular orientation and be constructed and operated in a particular orientation, and thus it is not to be construed as limiting the present application. Furthermore, the terms “first,” “second,” “third” and the like are used for descriptive purposes only and are not to be construed as indicating or implying a relative importance.

In the description of the present application, it is to be noted that unless explicitly stated and defined otherwise, the terms “installed,” “connected to,” and “connected” shall be understood broadly, for example, it may be either fixedly connected or detachably connected, or can be integrated; it may be either mechanically connected, or electrically connected; it may be either directly connected, or indirectly connected through an intermediate medium; or it may be the internal communication of two elements. The specific meanings of the terms above in the present application can be understood by a person skilled in the art in accordance with specific conditions.

In addition, in the description of the present application, unless otherwise statement, the terms “a plurality of,” “a plurality strips of,” and “a plurality sets of” means two or more.

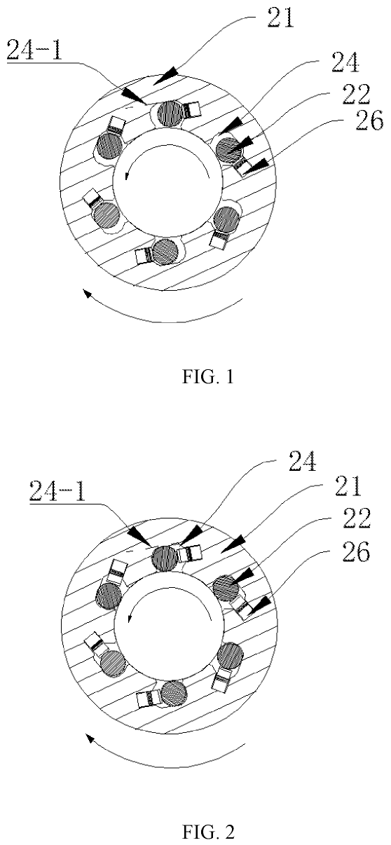

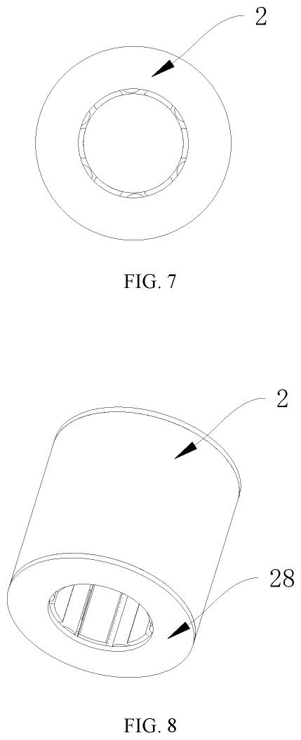

In a first aspect, refer to FIGS. 1-3, 7, and 8, a lock member 2 provided by the embodiments of the present application, includes a housing 21, a first movement body 22 and a first elastic member 26.

Specifically, the housing 21 has an axial through hole. A first open groove 24 is configured on an inner wall of the housing 21, that is, an inner wall of the axial through hole. An opening of the first open groove 24 faces an axis of the housing 21. A first movement surface 24-1 is provided on a groove bottom of the first open groove 24, and the groove bottom is a sidewall opposite to the opening. The first open groove 24 is composed of the opening, the sidewall opposite to the opening (i.e., the groove bottom) and sidewalls located on two sides relative to the groove bottom. Wherein, an end of the first movement surface 24-1 proximal to the opening of the first open groove 24 is a locking end, and an end of the first movement surface 24-1 distal to the opening of the first open groove 24 is an unlocking end.

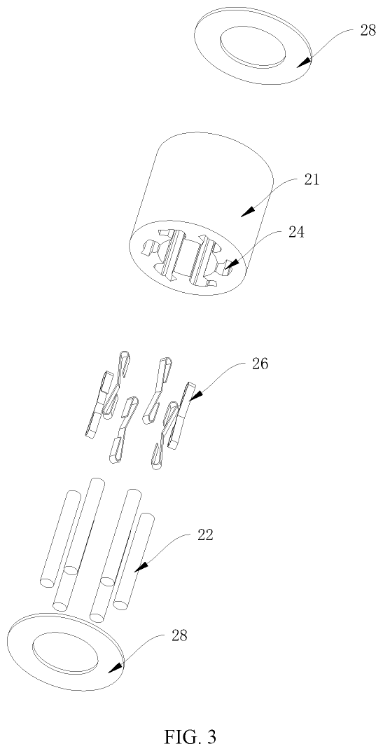

In this embodiment, the first movement surface 24-1 can be any one of bevel surface, arc surface and curved surface, or the first movement surface 24-1 can be any combination of the bevel surface, arc surface and curved surface, as long as the first movement body 22 is in a location far from the opening when unlocking, and the first movement body 22 is close to the opening when locking. The specific form of the first movement surface 24-1 can be selected according to actual needs, and is not specifically defined in this embodiment. In this embodiment, the first movement surface 24-1 being a bevel surface is taken as an example, where a dotted line in FIGS. 1-2 is an extension line of the first movement surface 24-1.

Wherein, the first movement body 22 is provided in the first open groove 24 and it can move along the first movement surface 24-1, so that it can switch between an unlocking end and a locking end according to a need.

In order to facilitate installation of the first movement body 22, the first movement body 22 can be inserted into the first open groove 24 from either of two ends of the first open groove 24.

Wherein, the first elastic member 26 is provided in the first open groove 24, and the first elastic member 26 can maintain the first movement body 22 at the locking end or the unlocking end of the first movement surface 24-1.

Specifically, the first elastic member 26 can be installed at the unlocking end of the first movement surface 24-1 or a position near the unlocking end of the first movement surface 24-1, and faces the first movement body 22. The first elastic member 26, in a natural state, maintains the first movement body 22 at the locking end of the first movement surface 24-1, and an outer surface of the opening of the first movement body 22 towards the first open groove 24 is tangent to a circumference of the inner wall of the housing 21, which allows an outmost end of the first movement body 22 to be on an inner circumference of the axial through hole of the housing 21.

When the driver assembly to be assembled is inserted into the housing 21, a direction indicated by an arrow in housing 21 as shown in FIGS. 1-2 is a rotation direction of the driver assembly. The first movement body 22 is in contact with the driver assembly to be assembled. Since there is no gap between the first movement body 22 and the driver assembly to be assembled, when the driver assembly rotates from the unlocking end to the locking end, the first movement body 22 is locked on the driver assembly to be assembled, and the lock member 2 can rotate synchronously with the driver assembly. When the driver assembly is not driven by external force to rotate, only elastic force of the first elastic member 26 holds the first movement body 22 against the driver assembly, then the lock member 2 can be separated from the driver assembly along an axial direction of the driver assembly, and only the elastic force of the first elastic member 26 and the friction between the two need to be overcome, which is very convenient and simple for consumers or users. Or when the driver assembly rotates from the locking end to the unlocking end, the driver assembly drives the first movement body 22 to move towards the unlocking end along the first movement surface 24-1 and presses the first elastic member 26. Since the space of the first open groove 24 at the unlocking end is large, when the first movement body 22 moves to the unlocking end, there is a gap between the first movement body 22 and the driver assembly, and when the driver assembly continues rotating, the lock member 2 remains stationary, so as to achieve the effect of one-way locking. At the same time, it is easy to separate the lock member 2 from the driver assembly along an axial direction of the driver assembly. That is, when the driver assembly does not rotate or the driver assembly rotates from the locking end to the unlocking end, it is easy to separate the lock member 2 from the driver assembly along the axial direction of the driver assembly. When the driver assembly is forced to rotate from the unlocking end to a direction where the locking end is located, in addition to rotate in a same direction with the driver assembly driven by the driver assembly, the lock member 2 can also be subjected to an external force to rotate in an opposite direction to the rotating direction of the driver assembly. As shown in FIGS. 1-2, a direction of an arrow outside the housing 21 is a direction of the external force. Through the external force, the locking between the driver assembly and the lock member 2 will be further strengthened. The external force can be a resistance of food, water, air, etc., in a mixing cup. And, due to the two opposite forces, and the elastic force of the first elastic member borne by the lock member 2 and the driver assembly, the lock member 2 and the driver assembly are further locked, that is, when the driver assembly is forced to rotate from the unlocking end to the locking end, the lock member 2 and the driver assembly are locked, and the lock member 2 cannot be separated from the driver assembly.

When there is a need to lock the lock member 2 with the driver assembly again, it only needs to rotate the driver assembly along the unlocking end towards the locking end. At this point, the first movement body 22 moves along the first movement surface 24-1 towards the locking end under the elastic force of the first elastic member 26. When the first movement body 22 moves to the locking end, it contacts with the driver assembly and locks on the driver assembly. And, the lock member 2 can rotate synchronously with the driver assembly.

When the lock member 2 is needed to be removed, the lock member 2 can be pulled out directly from the driver assembly when the driver assembly does not rotate or rotates from the locking end to the unlocking end, so as to realize the separation of the lock member 2 and the driver assembly. For the case of the rotary assembly fixed outside the housing 21, it is convenient to clean the rotary assembly.

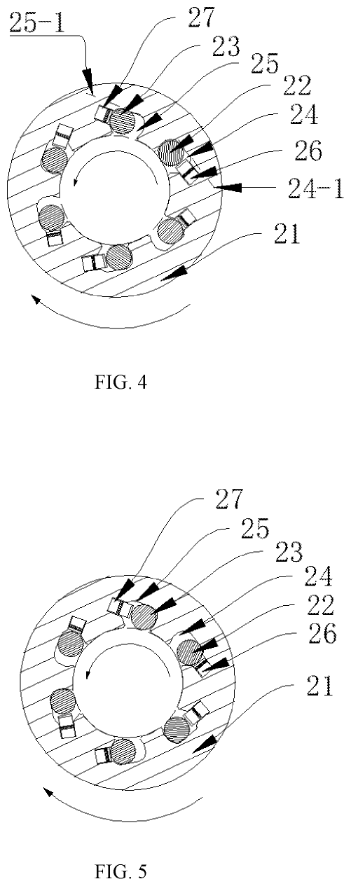

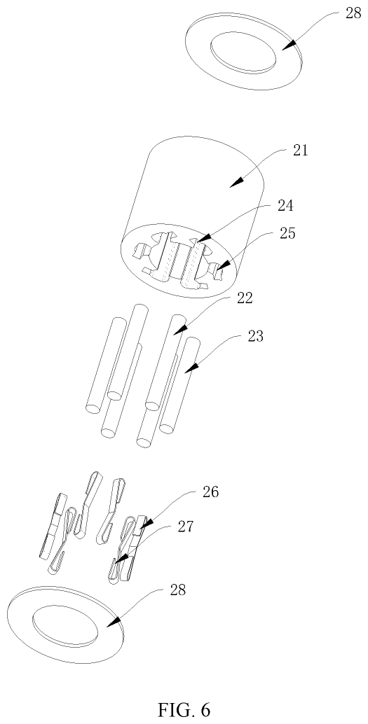

In another specific embodiment, refer to FIGS. 4-6, 7 and 8, the inner wall of the housing 21 is further provided with a second open groove 25, and a groove bottom of the second open groove 25 is provided with a second movement surface 25-1. A tilt direction of the second movement surface 25-1 is opposite to that of the first movement surface 24-1. For example, the tilt direction can be either clockwise or counterclockwise. If the first movement surface 24-1 points to the locking end from the unlocking end, then the second movement surface 25-1 can point to the unlocking end from the locking end.

In this embodiment, an end of the second movement surface 25-1 proximal to an opening of the second open groove 25 is the locking end, and an end of the second movement surface 25-1 distal to the opening of the second open groove 25 is the unlocking end.

In this embodiment, the second movement surface 25-1 can be any one of bevel surface, arc surface and curved surface, or the second movement surface 25-1 can be any combination of bevel surface, arc surface and curved surface, as long as the second movement body 23 is in a location far from the opening when unlocking, and the second movement body 23 is close to the opening when locking. The specific form of the second movement surface 25-1 can be selected according to actual needs, and is not specifically defined in this embodiment. In this embodiment, the second movement surface 25-1 being a bevel surface is taken as an example, where a dotted line in FIG. 4 is an extension line of the second movement surface 25-1.

The second movement body 23 is provided in the second open groove 25 and the second movement body 23 can move along the second movement surface 25-1, thus it can switch between the unlocking end and the locking end according to a requirement.

A second elastic member 27 is provided in the second open groove 25, and the second elastic member 27 can maintain the second movement body 23 at the locking end or the unlocking end of the second movement surface 25-1.

Specifically, the second elastic member 27 can be installed at the unlocking end of the second movement surface 25-1 or a position near the unlocking end of the second movement surface 25-1. In a natural state, the second elastic member 27 maintains the second movement body 23 at the locking end of the second movement surface 25-1, and an outer surface of the opening of the second movement body 23 towards the second open groove 25 is tangent to a circumference of the inner wall of the housing 21.

When the driver assembly to be assembled is inserted into the housing 21, as shown in FIGS. 4-5, a direction indicated by an arrow in the housing 21 is a rotation direction of the driver assembly. The first movement body 22 and the second movement body 23 are in contact with the driver assembly to be assembled. When the driver assembly rotates from the unlocking end to the locking end of the first movement surface 24-1, the first movement body 22 is locked on the driver assembly to be assembled, and the lock member 2 can rotate synchronously with the driver assembly. At this time, in addition to rotate in a same direction with the driver assembly driven by the driver assembly, the lock member 2 may also be subjected to an external force having an opposite direction to the rotating direction of the driver assembly. As shown in FIGS. 4-5, a direction of an arrow outside the housing 21 is a direction of the external force. Through the external force, the locking between the driver assembly and the lock member 2 will be further strengthened. The external force can be a resistance of food, water, air, etc., in a mixing cup. At the same time, the second movement body 23 moves towards the unlocking end along the second movement surface 25-1 and presses the second elastic member 27. Since the space of the second open groove 25 at the unlocking end is large, when the second movement body 23 moves to the unlocking end, there is a gap between the second movement body 23 and the driver assembly, that is, the second movement 23 is unlocked. When the driver assembly rotates from the locking end to the unlocking end of the first movement surface 24-1, the driver assembly drives the first movement body 22 to move towards the unlocking end along the first movement surface 24-1 and presses the first elastic member 26. Since the space of the first open groove 24 at the unlocking end is large, when the first movement body 22 moves to the unlocking end, there is a gap between the first movement body 22 and the driver assembly, that is, the first movement body 22 is unlocked. At the same time, the second movement body 23 moves along the second movement surface 25-1 towards the locking end under the elastic force of the second elastic member 27. When the second movement body 23 arrives at the locking end, it contacts with the driver assembly and is locked on the driver assembly. At this time, the driver assembly and the lock member 2 rotate synchronously, which plays a role of bidirectional locking.

In order to facilitate applying uniform force on the driver assembly, in a specific embodiment, there are a plurality of first open grooves 24, the plurality of first open grooves 24 are provided at intervals on the inner wall of the housing 21, and a direction of length of the plurality of first open grooves 24 extends along an axial direction of the housing 21.

In order to facilitate applying uniform force on the driver assembly, in a specific embodiment, there are a plurality of second open grooves 25, the plurality of second open grooves 25 are provided at intervals on the inner wall of the housing 21, and a direction of length of the plurality of second open grooves 24 extends along an axial direction of the housing 21.

In a specific embodiment, the first open grooves 24 and the second open grooves 25 are provided in pairs, and in a pair of the first open groove 24 and the second open groove 25, the extension of the first movement surface 24-1 of the first open groove 24 and the extension of the second movement surface 25-1 of the second open groove 25 are intersected. By providing the first open groove 24 and the second open groove 25 in pairs, it is convenient for the driver assembly to force uniformly.

Wherein, in the first open groove 24, a maximum width between the sidewalls located on two opposite sides of the groove bottom is larger than a width of the opening. For example, the first open groove 24 has a structure of its opening smaller than its inner space. From cross section views of FIGS. 1-2, 4 and 5, the first open groove 24 is narrowing from the inside to the opening. A diameter of the first movement body 22 is larger than the width of the opening of the first open groove 24 and smaller than the maximum width between the sidewalls located on two opposite sides of the groove bottom of the first open groove 24, such that after installing the first movement body 22 in the first open groove 24, the first movement body 22 will not be detached from the opening, thus improving the stability after installation.

In order to facilitate the installation of the first elastic member 26, in a specific embodiment, a sidewall at the unlocking end of the first movement surface 24-1 of the first open groove 24 is provided with a first installation groove which is configured to install the first elastic member 26. A tilt direction of the first installation groove is consistent with that of the first movement surface 24-1. Further, an inclination angle of the first installation groove can be set to be consistent with that of the first movement surface 24-1, so as to facilitate the elastic force of the first elastic member 26 acting to be applied onto the first movement body 22.

Wherein, in the second open groove 25, a maximum width between the sidewalls located on two opposite sides of the groove bottom is larger than a width of the opening. For example, the second open groove 25 also has a structure of its opening smaller than its inner space. From cross section views of FIGS. 4-5, the second open groove 25 is narrowing from the inside to the opening. A diameter of the second movement body 23 is larger than the width of the opening of the second open groove 25 and smaller than the maximum width between the sidewalls located on two sides relative to the groove bottom of the second open groove 25, such that after installing the second movement body 23 in the second open groove 25, the second movement body 23 will not be detached from the opening, thus improving the stability after installation.

In a specific embodiment, a sidewall at the unlocking end of the second movement surface 25-1 of the second open groove 25 is provided with a second installation groove which is configured to install the second elastic member 27. Atilt direction of the second installation groove is consistent with that of the second movement surface 25-1. Similarly, an inclination angle of the second installation groove can be set to be consistent with that of the second movement surface 25-1, so as to facilitate the elastic force of the second elastic member 27 to be applied onto the second movement body 23.

In order to facilitate reliable locating of the first movement body 22 at the locking end, in a specific embodiment, a sidewall at the locking end of the first movement surface 24-1 of the first open groove 24 is constructed to a first arc surface matched with an outer surface of the first movement surface 22. For example, when the outer surface of the first movement body 22 is cylindrical, the first arc surface is also cylindrical matched with the first movement body 22.

In order to facilitate reliable locating of the second movement body 23 at the locking end, in a specific embodiment, a sidewall at the locking end of the second movement surface 25-1 of the second open groove 25 is constructed to a second arc surface matched with an outer surface of the second movement surface 23. For example, when the outer surface of the second movement body 23 is cylindrical, the second arc surface is also cylindrical matched with the second movement body 23.

In a specific embodiment, the first movement body 22 and the second movement body 23 can be roller pins, rollers or balls. The first elastic member 26 and the second elastic member 27 can be springs. The specific form of spring is not limited, which can be compression spring or leaf spring. The spring used in this embodiment is leaf spring with two ends bent by a certain angle.

In a specific embodiment, at least one end of the housing 21 along the axial direction is provided with an end cover 28, so that a movement body or an elastic member will not be separated from ends of the housing 21 after installation. The end cover 28 is provided with a central through hole whose inner diameter is not less than that of the axial through hole of the housing 21 to ensure that the driver assembly such as the drive shaft 4 can be smoothly inserted into the axial through hole of the housing 21 and contact with the inner wall of the housing 21.

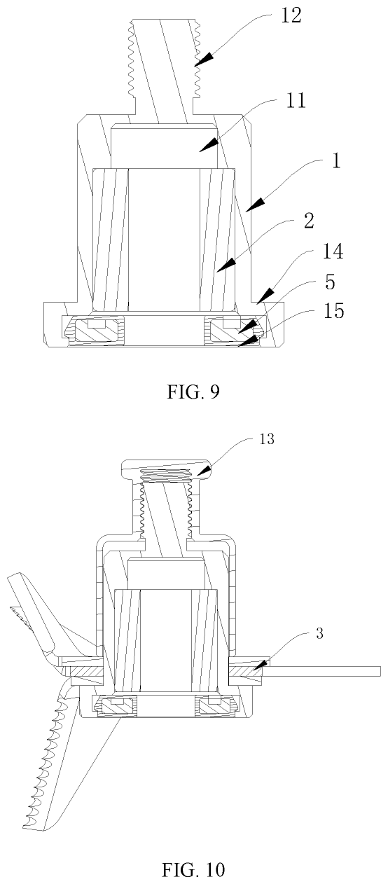

In a second aspect, refer to FIGS. 9-10, the embodiments of the present application provide a rotary head, including:
an installation sleeve 1, which has an installation space 11 on a lower end;
the lock member 2, which is fixed in the installation space 11 through the housing 21; and
a rotary actuator 3, which is fixed to an outer side of the installation sleeve 1.

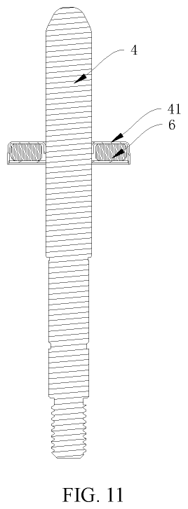

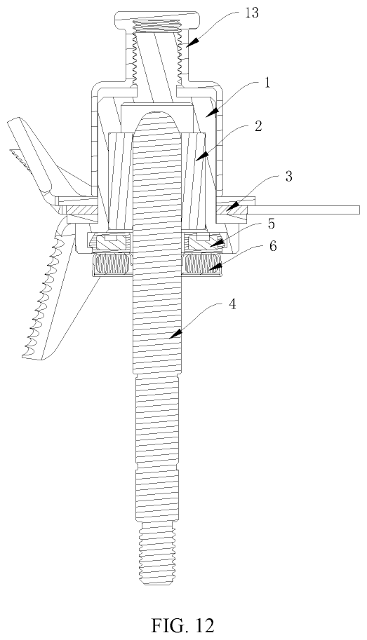

Refer to FIGS. 11-12, the rotary head is configured to be sleeved at the driver assembly, specifically, on the drive shaft 4. The first movement body 22 contacts with the drive shaft 4. When rotating the drive shaft 4 to make the first movement body 22 lock on the drive shaft 4, the rotary head can rotate synchronously with the drive shaft 4. And when rotating the drive shaft 4 reversely to drive the first movement body 22 to move to the unlocking end, there is a gap between the first movement body 22 and the drive shaft 4. When the drive shaft 4 rotates, the rotary head is fixed, thereby realizing the unidirectional locking and convenient disassembly of the rotary head.

In addition, a pair of coaxial lock members with opposite directions can be installed in the installation sleeve 1, such as two unidirectional bearings, so that the bidirectional locking of the rotary head can be realized, that is, the driver assembly can drive the rotary head to synchronously rotate forward or reverse. For occasions where the rotary head needs to rotate forward and reverse, requirements can be met by providing two unidirectional bearings with opposite directions in the installation sleeve 1.

For case that the lock member 2 has the second open groove 25, the second movement body 23 and the second elastic member 27, the rotating head is configured to be sleeved at the driver assembly, specifically, on the drive shaft 4. Both the first movement body 22 and the second movement body 23 contact with the drive shaft 4, thereby realizing bidirectional locking of the lock member 2 and the drive shaft 4, and ensuring that the lock member 2 can rotate synchronously with the drive shaft 4 in both forward and reverse directions; when the outside of the housing 21 fixed with a rotary head, the rotary head can rotate synchronously with the driver assembly in forward and reverse directions. Due to existence of locking force of the first movement body 22 or the second movement body 23, it can ensure that the rotary head will not be separated from the drive shaft 4 when rotating forwardly or reversely, and the connection is reliable and the use is safe.

When the drive shaft 4 does not rotate, the rotary head can be directly removed along the axial direction of drive shaft 4, so that the rotary head is easy to disassemble, and to be cleaned. Moreover, the installation sleeve 1, the lock member 2 and the rotary actuator 3 form an assembly, and the rotary head is disassembled as a whole during disassembly and assembly. There are no other extra parts, which avoids the situations where one or more parts are missing. The disassembly and assembly are fast, and it does not need disassembly tools or the users' checking whether the disassembly and assembly are in place. And repeated disassembly and assembly are available.

In addition, the lock member 2 is used as a part connected to the driver assembly, when the rotary head works, the first movement body 22 or the second movement body 23 is always stuck on the outer wall of the driver assembly, which can ensure that there is no gap between the driver assembly and the housing 21, thereby reducing noise and vibration of the rotary head during rotation and reducing the heat conduction between the rotary head and the driver assembly.

In order to ensure that there is no relative displacement between the installation sleeve 1 and the lock member 2 after assembly, and to ensure that the installation is convenient, in a specific embodiment, the inner surface of the installation space 11 is provided with a first structure, and the outer surface of housing 21 is provided with a second structure matching the first structure. After the housing 21 is assembled in the installation space 11, the lock member 2 is fixed on the inner surface of the installation sleeve 1. The first structure and the second structure are in a matching state, so as to drive the lock member 2 to rotate together when the installation sleeve 1 rotates along the axial direction.

Specifically, the first structure can be a convex part, a concave part or a plane part or a combination thereof constructed on the inner surface of the installation space 11. Accordingly, the second structure is a concave part, a convex part or a plane part or a combination thereof constructed on the outer surface of the housing 21.

It can be understood that the first structure can be a convex tooth or a plurality of convex teeth arranged at intervals formed on the inner surface of the installation space 11, or a groove or a plurality of grooves arranged at intervals formed on the inner surface of the installation space 11, or a plane or a plurality of planes formed on the inner surface of the installation space 11. And, the first structure can also be any combination of convex tooth, groove and plane, such as the combination of plane and convex tooth, or a combination of groove and plane, or a combination of convex tooth and groove, or a combination of convex tooth, groove and plane. Accordingly, the second structure is a groove, convex tooth or plane matching the first structure. The convex part can have other convex shapes, not limited to the convex tooth shape, and the shape of the concave part can be flat bottom groove or arc groove, the specific shape of the concave part can be set as required.

Specifically, the installation space 11 is a noncircular hole and the outer surface of the housing 21 is a noncircular surface.

In a specific embodiment, the noncircular hole can be polygonal hole, elliptical hole, or quasi-circular hole with at least one flat surface, etc. The specific form of the noncircular hole is not limited.

Of course, fixed installation methods of the installation sleeve 1 and the lock member 2 are not limited to above assembly methods. A fixed installation of the installation sleeve 1 and the lock member 2 can be realized in the following manner: the installation space 11 of installation sleeve 1 is a circular hole, the installation space 11 is in interference fit with the housing 21, or the installation sleeve 1 is provided with a spiral groove/spiral convex, and the housing 21 is provided with a spiral convex/spiral groove to match the spiral groove/spiral convex of the installation sleeve 1.

In a specific embodiment of the present application, an upper end of the installation sleeve 1 bulges upwards to form a connection member 12, such as a connecting column. An annular convex platform 14 is constructed outside the installation sleeve 1 at an opening side of the installation space 11, the rotary actuator 3 is sleeved outside the installation sleeve 1 and is supported against on the annular convex platform 14. The annular convex platform 14 plays a supporting role for the rotary actuator 3. The connection member 12 is detachably connected to a handle sleeve 13. For example, an external thread is provided on the connecting column, an internal thread is provided on a corresponding location of the handle sleeve 13, and the handle sleeve 13 and the connecting column are connected by thread to realize the detachable connection. The handle sleeve 13 is sleeved at an outer side of the installation sleeve 1, and is pressed on the rotary actuator 3, so as to press and fix the rotary actuator 3. In addition, the handle sleeve 13 is provided to facilitate the hand holding, so that when disassembling or assembling the rotary head, users' hands will not contact the rotary actuator 3.

In addition, the handle sleeve 13 can also be directly formed on the connection member 12, that is, the handle sleeve 13 and the connection member 12 is an integrated structure.

The lock member 2 is compact in size and occupies a small space of the installation sleeve 1, so it is beneficial to reduce a volume of the installation sleeve 1 and a volume of the whole rotary head, and to compact structure and miniaturization of the rotary head.

In a specific embodiment of the present application, the rotary head can further include a sealing member 15, which is provided at a lower end of the lock member 2 to prevent residue from entering the inner of the lock member 2 and thus affecting service life and performance of the lock member 2.

In order to facilitate locating of the sealing member 15, the sealing member 15 is at least partially provided in the installation space 11, and is located at an opening side of the installation sleeve 1. The sealing member 15 can be a sealing ring. A peripheral of the sealing ring and an inner circumference of the lower end of the installation space 11 is in interference fit, a center of the sealing ring is provided with a hole for the driver assembly to pass through, and a sealing surface of the sealing ring is close to a lower surface of the lock member 2.

As shown in FIGS. 9-10, in a specific embodiment of the present application, the rotary head also includes a first magnetic member 5, and the first magnetic member 5 is fixed at the opening side of the installation space 11. In this embodiment, the first magnetic member 5 is provided in the installation sleeve 1 and close to a lower end of the lock member 2. In addition, for case of providing the sealing member 15, the sealing member 15 is provided between the lock member 2 and the first magnetic member 5. The installation position of the first magnetic member 5 is not limited in the installation sleeve 1, but also can be fixed to an outer side of the installation sleeve 1 near the opening side. Since the rotary head has the first magnetic member 5, when assembling the rotary head, the first magnetic member 5 is closest to the driver assembly, and then the rotary head can be fixed on the driver assembly through attraction cooperation between the first magnetic member 5 and corresponding magnetic member on the driver assembly, so as to prevent the rotary head from separating from the driver assembly under specific conditions such as large tilt angle.

Wherein, the first magnetic member 5 refers to an object that can react in some way to a magnetic field and does not require itself to have a capacity of producing a magnetic field. The first magnetic member 5 can be prepared by any magnetic material, such as magnet, low carbon steel, etc. Of course, the first magnetic member 5 can also be an electrified coil. Similarly, the second magnetic member 6 mentioned below can also be prepared by any magnetic material or in a form of an electrified coil. Specific forms of the first magnetic member 5 and the second magnetic member 6 are not limited, as long as the first magnetic member 5 and the second magnetic member 6 can produce magnetic attraction.

In a specific embodiment of this application, the rotary actuator 3 can include rotary knife, rotary hook, rotary claw, rotary rod, rotary paddle or any combination thereof. For example, soybean milk machine, high speed blender and juice extractor are generally equipped with rotary knife; and dough kneading machine is generally equipped with rotary hook. In addition, paint mixing machine, pretreatment system of crop fermentation raw material and powder coating mixer, etc., are generally equipped with rotary hook; superhard abrasive mixing machine, egg beater, food machine, biological fertilizer mixing machine, etc., are generally equipped with the rotary claw; and reaction still, food machine, etc., are generally equipped with the rotary rod; and mixing machine, reaction are generally equipped with rotary paddle.

In addition, according to various use requirements, a combination of a variety of rotary actuator 3, such as rotary knife and rotary paddle, can be used to achieve better effect of cutting and stirring.

In addition, the embodiments of the present application further provide a rotary assembly. As shown in FIGS. 11-12, the rotary assembly includes the driver assembly and the rotary head, wherein, the rotary head is sleeved at the driver assembly; the first movement body 22 contacts with the driver assembly. When rotating the driver assembly towards the locking end, the first movement body 22 is locked on the driver assembly and rotates synchronously with the driver assembly. When reversely rotating the driver assembly, the first movement body 22 moves towards the unlocking end along the first movement surface 24-1 and presses the first elastic member 26. And there is a gap between the first movement body 22 and the driver assembly. When the driver assembly rotates, the rotary head is fixed and a unidirectional locking of the rotary head is realized.

In addition, for case that the lock member 2 is provided with the first open groove 24, the second open groove 25 and the corresponding parts, the lock member 2 can realize bidirectional locking, so that the rotary head and the driver assembly can realize bidirectional locking, which ensures that the rotary head is not separated from the driver assembly during forward or reverse rotation, connection is reliable and use is safe.

When the rotary head needs to be detached, the rotary head can be pulled directly from the driver assembly, so that the rotary head is easy to disassemble and clean. Moreover, the installation sleeve 1, the lock member 2 and the rotary actuator 3 form an assembly, and the rotary head is disassembled as a whole during disassembly and assembly. There are no other extra parts, which avoids the existence of one or more parts being forgotten. The disassembly and assembly can be performed fast without disassembly tools, and after the disassembly and assembly, the user doesn't need to check whether the disassembly and assembly are in place. And a repeated disassembly and assembly are available. In addition, it's easy to assemble or disassemble without checking or interfering with an orientation of the driver assembly.

In addition, a separation force required for disassembling the rotary head is less than 20 N, and the rotary head can be directly pulled out by hand without using a tool.

In a specific embodiment, the driver assembly such as the drive shaft 4 can be a rotating body, such as a bare shaft, without key groove, key and other complex structure thereon. When assembling, the drive shaft 4 can be directly inserted into the housing 21, without alignment. Thus the installation is very simple and fast.

The above rotary assembly can be applied to low speed and high speed range of 1 RPM (Revolutions Per Minute abbreviation) ˜40000 RPM.

In a specific embodiment, as shown in FIG. 11, the rotary assembly further includes the second magnetic member 6, which is fixed on the driver assembly and is provided opposite to the first magnetic member 5 of the rotary head, and the first magnetic member 5 and the second magnetic member 6 attract each other by magnetic force. Specific material of the first magnetic member 5 and the second magnetic member 6 are not limited. In an embodiment, the first magnetic member 5 is made from low carbon steel such as low carbon steel retaining ring, and the second magnetic member 6 is made from magnet, so that it will produce mutual attraction between low carbon steel retaining ring and magnet, which ensures that the rotary head will not separate from the driver assembly even in a dumping state, making it user-friendly.

In a specific embodiment of the present application, in order to locate and support the lower end of the lock member 2 and avoid downward movement of the lock member 2, a locating shaft shoulder is provided on the driver assembly, and the bottom of the inner circumference of the lock member 2 is leaned against on the locating shaft shoulder. For case of providing a sealing ring at the lower end of the lock member 2, the bottom of the sealing ring is leaned against on the locating shaft shoulder, which plays a role of locating and supporting for the lock member 2 and the sealing ring.

Furthermore, as shown in FIG. 11, an annular hollow cover body 41 is arranged on the drive shaft 4, and a locating shaft shoulder is formed between an upper surface of the annular hollow cover body 41 and the drive shaft 4. The annular hollow cover body 41 can be integrated with the drive shaft 4. An outer diameter of the annular hollow cover body 41 needs to be greater than an inner diameter of the lock member 2. In order to facilitate the installation of the second magnetic member 6, the second magnetic member 6 can be provided in a cavity of the annular hollow cover body 41.

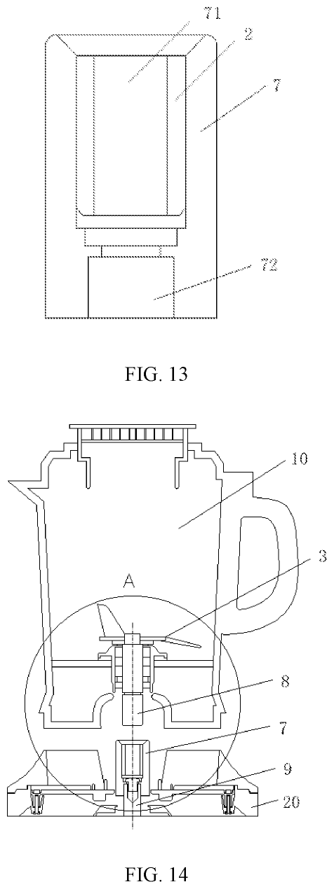

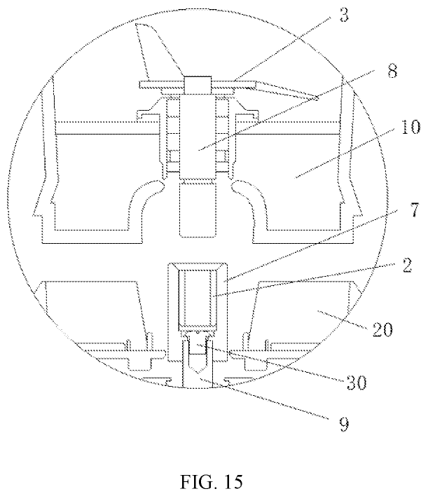

In addition, the present application further provides a container, as shown in FIGS. 14-15, which comprising a container body 10 and the above rotating assembly. An end of the driver assembly is installed in the container body 10. Specifically, the bottom of the container body 10 can be provided with an installation space 11, the driver assembly is to connect electrically to a driving mechanism such as driving motor after running through the installation space 11. The connection between the driver assembly and the installation space 11 is sealed to ensure no leakage. The rotary head is sleeved at another end of the driver assembly through the housing 21. The driver assembly is driven to rotate by the driving motor, thus driving the rotating head to rotate. In addition, in order to avoid providing holes at the bottom of the container body 10, an output shaft end of the driving motor can be provided with a first coupler. The first coupler is located at a bottom outside the container body 10, and a lower end of the driver assembly in the container body 10 is provided with a second coupler. The driving motor drives the first coupler to rotate to generate magnetic force to drive the second coupler to rotate, thereby driving the rotation of the driver assembly and the rotary head.

For the container provided by this embodiment, by providing the driver assembly and the rotary head sleeved at the driver assembly in the container body 10, the rotary head can realize reliable connection with the driver assembly when working, and the rotary head can be pulled out directly when it needs to be disassembled. Thus the rotary head is convenient to disassemble and clean. It is also convenient to clean a bottom of the container after the rotary head is removed, so as to avoid the residue gathering at the bottom of the container, especially near the bottom of the driver assembly, thereby the container can be cleaned thoroughly and there isn't any sanitary dead angle, then the user's inconvenience can be solved and the users' satisfaction can be improved.

In addition, as shown in FIG. 12, due to magnetic attraction between the first magnetic member 5 and the second magnetic member 6, the rotary head can be avoided sliding due to gravity when the container is tilting.

On another hand, the embodiments of the present application provide a food processor, which comprises the above container. The food processor can be soybean milk machine, high speed blender, juice extractor, egg beater, dough kneading machine, food mixer, air fryer, shredder, filament planer, self-cooking pan, frying pan, soup-making machine or self-frying pan, etc. The rotary head of the food processor can be reliably connected to the driver assembly when working, which improves the safety of use. It is convenient to disassemble when cleaning is needed, which is also convenient to remove the rotary head and clean the bottom of the food processor after removing the rotary head. Thus, the food processor can be thoroughly cleaned without any sanity dead angle. Moreover, it is safe to use and will not cut users' hands, which improves users' satisfaction and the premium capacity of product.

In addition, when materials in the food processor needs to be dumped, due to the magnetic attraction between the first magnetic member 5 and the second magnetic member 6, the rotary head can be avoided from sliding due to gravity. Thus it's convenient to use.

What's more, refer to FIG. 13, embodiments of the present application further provide a shaft coupler, including a shaft coupler body 7. A first end of the shaft coupler body 7 is provided with a first connection hole 71 and a second end of the shaft coupler body 7 is provided with a second connection hole 72. The shaft coupler further includes:
the lock member 2, and the specific structure of the lock member 2 is shown in FIGS. 1-8, which is not repeated here; and
the housing 21 is fixed in the first connection hole 71, and is configured to be sleeved at the first drive shaft assembly. When installing, it is only need to insert the first drive shaft assembly in the housing 21 or sleeve the housing 21 on the first drive shaft assembly. The installation is very convenient and fast, without alignment and without adjusting an installation angle. By providing the lock member 2 as a part connected to the first drive shaft assembly, the first movement body 22 is always locked in an outer wall of the first drive shaft assembly when the shaft coupler works, which can ensure that there is no gap between the first drive shaft assembly and the housing 21, thereby reducing noise and vibration of the shaft coupler during rotation.

In this embodiment, the first drive shaft assembly being the first drive shaft 8 is taken as an example to illustrate.

The second connection hole 72 is configured to be fixedly connected to the second drive shaft assembly, and the housing 21 can be synchronously rotated by rotating the second drive shaft assembly. Therefore, when the housing 21 needs to be rotated, it is only necessary to rotate the second drive shaft assembly.

In a specific embodiment, the first connection hole 71 and the second connection hole 72 are coaxially arranged and disconnected from each other, so as to facilitate respective installation of the first drive shaft assembly and the second drive shaft assembly without mutual interference.

On another hand, embodiments of the present application further provide a rotary assembly. As shown in FIGS. 14-15, the rotary assembly includes a first drive shaft assembly and a second drive shaft assembly, and further includes: the shaft coupler which is fixedly connected to the second drive shaft assembly and is sleeved at the first drive shaft assembly through the housing 21. It's very convenient to assemble, without alignment and without adjusting an installation angle.

When the shaft coupler and the first drive shaft assembly need to be disassembled, only a small force is required to separate the shaft coupler and the first drive shaft assembly, which is easy to disassemble.

In addition, the first drive shaft assembly such as the first drive shaft 8 can be a rotating body, such as a bare shaft without key groove, key and other complex structure thereon. When assembling, the first drive shaft 8 only needs to be directly inserted into the housing 21, without alignment. Thus the installation is very simple and fast.

The second drive shaft assembly is fixedly connected to the second connection hole 72 through a fastener 30, and an upper end of the second drive shaft assembly can be provided with the installation space 11. One end of the fastener 30, such as a screw, is fixed in the installation space 11, and the other end of the fastener 30 is fixed in the second connection hole 72, thereby realizing a fixed connection between the second drive shaft assembly and the shaft coupler. The second drive shaft assembly can be the second drive shaft 9 or a structure of a shaft sleeve outside the second drive shaft 9.

As shown in FIGS. 14-15, embodiments of the present application further provide a container, including a container body 10, such as a stirring cup, and a base 20, and a rotary assembly. One of the first drive shaft assembly and the second drive shaft assembly is connected to the container body 10 and extends into the container body 10, and the other of the first drive shaft assembly and the second drive shaft assembly is connected to the base 20.

That is, if the first drive shaft assembly is connected to the container body 10, the second drive shaft assembly is connected to the base 20, and accordingly, if the second drive shaft assembly is connected to the container body 10, the first drive shaft assembly is connected to the base 20. In this embodiment, the first drive shaft 8 is connected to the container body 10, the second drive shaft 9 is connected to the base 20, and the container body 10 is used as a moving part. A lower end of the first drive shaft 8 is inserted into the housing 21 of the lock member 2 on the base 20, and the assembly and the disassembly are convenient.

Of course, the second drive shaft 9 can be connected to the container body 10, a lower end of the second drive shaft 9 is fixedly connected to the shaft coupler, the first drive shaft 8 is connected to the base 20. And when the container body 10 is connected to the base 20, the container body 10 drives the housing 21 to be sleeved at the first drive shaft assembly.

In this embodiment, the first drive shaft assembly only needs to be inserted into the housing 21 during installation, which is easy to install and does not need to rotate the container body 10 to adjust an angle. The installation is fast, time-saving and labor-saving. When working, the housing 21 can be clamped with the first drive shaft assembly to ensure that there is no gap between the first drive shaft assembly and the housing 21. When rotating, it is more stable, with small vibration and noise, and relatively small heat generation, which solves inconvenience of users.

Specifically, one end of the first drive shaft assembly or the second drive shaft assembly extended into the container body 10 is provided with a rotary actuator 3; the base 20 is provided with a power mechanism such as a motor; an end of the first drive shaft assembly or the second drive shaft assembly connected to the base 20 is connected to the power mechanism; or an output shaft of the power mechanism can be used as the first drive shaft assembly or the second drive shaft assembly connected to the base 20.

In a specific embodiment, an end of the first drive shaft assembly or the second drive shaft assembly extending into the container body 10 is provided with the rotary actuator 3; the base 20 is provided with a power mechanism; and an end of the first drive shaft assembly or the second drive shaft assembly connected to the base 20 is connected to the power mechanism.

On another hand, embodiments of the present application provide a food processor, such as soybean milk machine, high speed blender, juice extractor, egg beater, dough kneading machine, food mixer, air fryer, shredder, filament planer, self-cooking pan, frying pan, soup-making machine or self-frying pan, etc., which includes a container. As shown in FIGS. 14-15, by using the above container in the food processor, the container body 10 and the base 20 can be fast connected and conveniently disassemble. It ensures that there is no gap between the shaft coupler and the first drive shaft assembly when the food processor is working, the rotation is more stable with small vibration, noise and relatively small heat generation, which improves users' satisfaction and the premium capacity of product.

According to the above embodiments, the lock member 2 can realize both one-way locking, and two-way locking, and is easy to be detached; the rotary head is easy to disassemble and assemble, easy to clean, and safe to use, and can be automatically locked with the driver assembly when the rotary head is working, thereby the connection is reliable, and working stability and safety are improved.

The shaft coupler of the embodiments of the present application is easy to disassemble and assemble, and the shaft coupler can be automatically locked with the first drive shaft assembly when working, thereby the connection is reliable, working stability is improved, vibration and noise are reduced, and the heat generation is relatively small.

The above-mentioned are only some embodiments of the present application, and are not intended to limit the present application. Any modifications, equivalent substitutions, and improvements made within the concept of the present application shall be included in the protection scope of the present application.

1.-28. (canceled)

29. A lock member comprising:
a housing including an open groove at an inner wall of the housing, a bottom of the open groove being provided with a movement surface, an end of the movement surface proximal to an opening of the open groove being a locking end, and an end of the movement surface distal to the opening of the open groove being an unlocking end;
a movement body provided in the open groove and moveable along the movement surface; and
an elastic member provided in the open groove and configured to maintain the movement body at the locking end or the unlocking end of the movement surface.

30. The lock member according to claim 29, wherein:
the open groove is a first open groove, the movement surface is a first movement surface, the locking end is a first locking end, the unlocking end is a first unlocking end, the movement body is a first movement body, and the elastic member is a first elastic member;
the housing further includes a second open groove at the inner wall of the housing, a bottom of the second open groove being provided with a second movement surface, and a tilt direction of the second movement surface being opposite to a tilt direction of the first movement surface;
an end of the second movement surface proximal to an opening of the second open groove is a second locking end, and an end of the second movement surface distal to the opening of the second open groove is a second unlocking end;
a second movement body is provided in the second open groove, and the second movement body is moveable along the second movement surface; and
a second elastic member is provided in the second open groove, and the second elastic member is configured to maintain the second movement body at the second locking end or the second unlocking end of the second movement surface.

31. The lock member according to claim 30, wherein the second open groove is one of a plurality of second open grooves disposed at intervals at the inner wall of the housing, and a length direction of each of the plurality of second open grooves extends along an axial direction of the housing.

32. The lock member according to claim 30, wherein:
the second elastic member is installed at the unlocking end of the second movement surface or at a position near the unlocking end of the second movement surface;
the second elastic member, when in a natural state, maintains the second movement body at the locking end of the second movement surface; and
an outer surface of the second movement body towards the opening of the second open groove is tangent to a circumference of the inner wall of the housing.

33. The lock member according to claim 30, wherein:
a maximum width between opposite sidewalls of the second open groove is larger than a width of the opening of the second open groove; and
a diameter of the second movement body is larger than the width of the opening of the second open groove and smaller than the maximum width between the opposite sidewalls of the second open groove.

34. The lock member according to claim 30, wherein:
a sidewall of the second open groove located at the second unlocking end of the second movement surface is provided with an installation groove for the second elastic member; and
a tilt direction of the installation groove is consistent with a tilt direction of the second movement surface.

35. The lock member according to claim 30, wherein a sidewall of the second open groove at the second locking end of the second movement surface is constructed as an arc surface matching an outer surface of the second movement body.

36. The lock member according to claim 30, wherein each of the first movement body and the second movement body includes a roller pin, a roller, or a ball, and each of the first elastic member and the second elastic member includes a spring.

37. The lock member according to claim 29, wherein the first open groove is one of a plurality of first open grooves disposed at intervals at the inner wall of the housing, and a length direction of each of the plurality of first open grooves extends along an axial direction of the housing.

38. The lock member according to claim 29, wherein:
the elastic member is installed at the unlocking end of the movement surface or at a position near the unlocking end of the movement surface;
the elastic member, when in a natural state, maintains the movement body at the locking end of the movement surface; and
an outer surface of the movement body towards the opening of the open groove is tangent to a circumference of the inner wall of the housing.

39. The lock member according to claim 29, wherein:
a maximum width between opposite sidewalls of the open groove is larger than a width of the opening of the open groove; and
a diameter of the movement body is larger than the width of the opening of the open groove and smaller than the maximum width between the opposite sidewalls of the open groove.

40. The lock member according to claim 29, wherein:
a sidewall of the open groove located at the unlocking end of the movement surface is provided with an installation groove for the elastic member; and
a tilt direction of the installation groove is consistent with a tilt direction of the movement surface.

41. The lock member according to claim 29, wherein a sidewall of the open groove at the locking end of the movement surface is constructed as an arc surface matching an outer surface of the movement body.

42. The lock member according to claim 29, wherein at least one end of the housing along an axial direction of the housing has an end cover, the end cover has a central through hole, and an inner diameter of the central through hole is not small than an inner diameter of an axial through hole of the housing.

43. A rotary head comprising:
an installation sleeve, having an installation space at a lower end of the installation sleeve;
a lock member including:
a housing, the lock member being fixed in the installation space through the housing, the housing including an open groove at an inner wall of the housing, a bottom of the open groove being provided with a movement surface, an end of the movement surface proximal to an opening of the open groove being a locking end, and an end of the movement surface distal to the opening of the open groove being an unlocking end;
a movement body provided in the open groove and moveable along the movement surface; and
an elastic member provided in the open groove and configured to maintain the movement body at the locking end or the unlocking end of the movement surface; and
a rotary actuator fixed outside the installation sleeve.

44. The rotary head according to claim 43, wherein:
an upper end of the installation sleeve bulges upwards to form a connection member;
an annular convex platform is constructed outside the installation sleeve at an opening side of the installation space;
the rotary actuator is fixed to an outer side of the installation sleeve and abuts at the annular convex platform;
the connection member is connected to a handle sleeve; and
the handle sleeve is sleeved at the outer side of the installation sleeve and is pressed at the rotary actuator.

45. The rotary head according to claim 43, further comprising at least one of:
a sealing member at a lower end of the lock member, the sealing member being at least partially disposed in the installation space and located at an opening side of the installation space; or
a magnetic member fixed at the opening side of the installation space.

46. A rotary assembly comprising:
a driver assembly; and
a rotary head sleeved at the driver assembly and including:
a housing including an open groove at an inner wall of the housing, a bottom of the open groove being provided with a movement surface, an end of the movement surface proximal to an opening of the open groove being a locking end, and an end of the movement surface distal to the opening of the open groove being an unlocking end;
a movement body provided in the open groove and moveable along the movement surface, the movement body contacting the driver assembly; and
an elastic member provided in the open groove and configured to maintain the movement body at the locking end or the unlocking end of the movement surface.

47. The rotary assembly according to claim 46,
wherein the rotary head further includes a first magnetic member;
the rotary assembly further comprising:
a second magnetic member fixed at the driver assembly and opposite to the first magnetic member of the rotary head;
wherein the first magnetic member and the second magnetic member magnetically attract each other.

48. A container comprising:
a container body; and
the rotary assembly according to claim 46;
wherein an end of the driver assembly is installed in the container body, and the rotary head is sleeved at another end of the driver assembly.
